(19) United States
(12) Patent Application Publication
(10) Pub. No.: US 2020/0133222 A1
(43) Pub. Date: Apr. 30, 2020

(54) OBJECT ATTACHMENT CONTROL METHOD, ATTACHING MACHINE AND STORAGE MEDIUM

(71) Applicant: HKC Corporation Limited, Shenzhen (CN)

(72) Inventors: Lin Qin, Shenzhen (CN); Wanghong Xu, Shenzhen (CN); Kuodien Huang, Shenzhen (CN)

(21) Appl. No.: 16/398,269

(22) Filed: Apr. 30, 2019

Related U.S. Application Data
(63) Continuation of application No. PCT/CN2018/114679, filed on Nov. 9, 2018.

(30) Foreign Application Priority Data
Oct. 25, 2018 (CN) 201811255758.4

(51) Int. Cl. G05B 19/05

(52) U.S. Cl. CPC G05B 19/058; G05B 2219/23206

(57) ABSTRACT

Disclosed are an object attachment control method, attaching machine and storage medium, the object attachment control method comprising the following steps: acquiring the attachment precision values of predetermined number of objects; calculating attachment compensation amounts according to the attachment precision values and a preset standard value; and correcting the attachment precision values of corresponding objects to be attached according to the attachment compensation amounts.

### CROSS REFERENCE TO RELATED APPLICATIONS

The present application is a Continuation Application of PCT Application No. PCT/CN2018/114679 filed on Nov. 9, 2018, which claims the benefit of Chinese Patent Application No. 201811255758.4 filed on Oct. 25, 2018. All the above are hereby incorporated by reference.

### FIELD OF THE DISCLOSURE

The present application relates to the field of displays, and in particular, to an object attachment control method, attaching machine and storage medium.

### BACKGROUND OF THE DISCLOSURE

Polarizing plate attachment precision is one of key indicators to evaluate a polarizing attachment process. However, the precision value inevitably fluctuates in the polarizing plate attachment process due to the action error of a polarizing plate attaching machine and material difference of the polarizing plate. When a polarizing plate is attached on glass and conversion is out of specification value range, the correction thereof consumes manpower, time and resources. Furthermore, a worktable end would slow the machine and influence production, with the result that CPK (referring to the actual processing capability of a process step in a certain time under a controlled state) cannot reach a standard, and the quality of the product would be poor.

The worktable of the polarizing plate attaching machine has an attachment precision automatic detection function. When precision displacement fluctuation exceeds the standard, the glass would disappear from a human eye examination portion, and an alarm would be given to prompt the operator to confirm. In the prior art, the attachment precision offset degree is confirmed mainly by an operator; a compensation amount is calculated according to the offset degree; and the machine is required to be shut down to manually compensate the attachment precision via a position alignment system.

However, the applicant of the present application finds out that the above technology at least has the following technical problems:

1. Only a plurality of worktables are shut down, can precision be compensated, thus consuming much time, and influencing product capacity and device utilization rate:

2. The plurality of worktables are divided into a polarizing plate attached to a thin film transistor (TFT) and a polarizing plate attached to a color filter (CF); furthermore, the adjustment parameters of each worktable comprise the parameters in X direction, Y direction and θ direction. Therefore, the compensation performed via personal calculation and manual operation would inevitably make mistakes; and

3. The unstable fluctuation of the polarizing plate attachment precision is overcome by an operator only. However, the operator cannot monitor the correction in real time. Therefore, the CPK would be difficult to reach the standard, and the polarizing plate attachment precision cannot remain a good stable state.

### SUMMARY OF THE DISCLOSURE

An embodiment of the present application provides an object attachment control method, and solves the problems in the prior art that when the attachment precision is manually compensated, the existing technology consumes much time, influences product capacity and device utilization rate, is easy to make mistakes, and cannot remain the attachment precision in a stable state. The present application does not require shutting down the machine during attachment precision compensation, does not influence the product capacity of the machine, can avoid the problem that personal compensation amount calculation and manual operation are easy to make mistakes, can realize real time monitoring and automatic correction, and can remain the object attachment precision in a good stable state.

An embodiment of the present application provides an object attachment control method, comprising the following steps:

Acquiring the attachment precision values of predetermined number of objects;

Calculating attachment compensation amounts according to the attachment precision values and a preset standard value; and

Correcting the attachment precision values of corresponding objects to be attached according to the attachment compensation amounts.

Alternatively, the step of acquiring the attachment precision values of predetermined number of objects comprises:

Using a programmable logic controller program to acquire the attachment precision values of predetermined number of objects.

Alternatively, before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range.

Alternatively, the step of acquiring the attachment precision values of predetermined number of objects comprises:

Using a programmable logic controller program to acquire the attachment precision values of predetermined number of objects;

Before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range.

Alternatively, the step of calculating attachment compensation amounts according to the attachment precision values and a preset standard value comprises:

Calculating the average of the attachment precision values; and

Comparing the average with the preset standard value to acquire the attachment compensation amounts.

Alternatively, the step of acquiring the attachment precision values of predetermined number of objects comprises:

Using a programmable logic controller program to acquire the attachment precision values of predetermined number of objects;

The step of calculating attachment compensation amounts according to the attachment precision values and a preset standard value comprises:

Calculating the average of the attachment precision values; and

Comparing the average with the preset standard value to acquire the attachment compensation amounts.

Alternatively, before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range;

The step of calculating attachment compensation amounts according to the attachment precision values and a preset standard value comprises:

Calculating the average of the attachment precision values; and

Comparing the average with the preset standard value to acquire the attachment compensation amounts.

Alternatively, the step of acquiring the attachment precision values of predetermined number of objects comprises:

Using a programmable logic controller program to acquire the attachment precision values of predetermined number of objects;

Before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range;

The step of calculating attachment compensation amounts according to the attachment precision values and a preset standard value comprises:

Calculating the average of the attachment precision values; and

Comparing the average with the preset standard value to acquire the attachment compensation amounts.

Alternatively, after the step of correcting the attachment precision values of corresponding objects to be attached according to the attachment compensation amounts, the method further comprises:

after N (N≥1) number of the objects, re-acquiring the attachment precision values of predetermined number of objects;

Alternatively, before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range;

After the step of correcting the attachment precision values of corresponding objects to be attached according to the attachment compensation amounts, the method further comprises:

after N (N≥1) number of the objects, re-acquiring the attachment precision values of predetermined number of objects;

Alternatively, the step of acquiring the attachment precision values of predetermined number of objects comprises:

Using a programmable logic controller program to acquire the attachment precision values of predetermined number of objects;

After the step of correcting the attachment precision values of corresponding objects to be attached according to the attachment compensation amounts, the method further comprises:

After N (N≥1) number of the objects, re-acquiring the attachment precision values of predetermined number of objects;

Alternatively, the step of calculating attachment compensation amounts according to the attachment precision values and a preset standard value comprises:

Calculating the average of the attachment precision values; and

Comparing the average with the preset standard value to acquire the attachment compensation amounts;

After the step of correcting the attachment precision values of corresponding objects to be attached according to the attachment compensation amounts, the method further comprises:

After N (N≥1) number of the objects, re-acquiring the attachment precision values of predetermined number of objects;

Alternatively, before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range;

The step of calculating attachment compensation amounts according to the attachment precision values and a preset standard value comprises:

Calculating the average of the attachment precision values; and

Comparing the average with the preset standard value to acquire the attachment compensation amounts;

After the step of correcting the attachment precision values of corresponding objects to be attached according to the attachment compensation amounts, the method further comprises:

after N (N≥1) number of the objects, re-acquiring the attachment precision values of predetermined number of objects;

Alternatively, the step of acquiring the attachment precision values of predetermined number of objects comprises:

Using a programmable logic controller program to acquire the attachment precision values of predetermined number of objects;

Before the step of acquiring the attachment precision values of predetermined number of objects, the method further comprises:

Acquiring the attachment precision values of all the objects; and

Filtering and screening the attachment precision values of all the objects, and acquiring the attachment precision values in a preset specification value range;

The step of calculating attachment compensation amounts according to the attachment precision values and a preset standard value comprises:

Calculating the average of the attachment precision values; and

Comparing the average with the preset standard value to acquire the attachment compensation amounts;

After the step of correcting the attachment precision values of corresponding objects to be attached according to the attachment compensation amounts, the method further comprises:

After N (N≥1) number of the objects, re-acquiring the attachment precision values of predetermined number of objects;

Alternatively, actual compensation amount=attachment compensation amount×compensation capability, wherein 0<compensation capability<100%; and the step of correcting the attachment precision values of corresponding objects to be attached according to the attachment compensation amounts comprises:

Calculating actual compensation amounts according to the attachment compensation amounts, and correcting the attachment precision values of corresponding objects to be attached according to the actual compensation amounts.

The compensation capability is adjustable; and the adjustment range of the compensation capability is: 1%<compensation capability<100%.

Alternatively, the objects are polarizing plates.

The present application further provides an attaching machine, comprising a memory, a processor, a precision detector, a worktable for attaching an object, and an object attachment control program stored in the memory and capable of running on the processor, wherein the precision detector is disposed on the worktable, and is electrically connected to the processor; and the object attachment control program, when executed by the processor, realizes the steps of the above-described object attachment control method.

The present application further provides a storage medium, stored with an object attachment control program for, when executed, realizing the steps of the above-described object attachment control method.

In the embodiment of the present application, by acquiring the attachment precision values of predetermined number of objects, calculating attachment compensation amounts according to the attachment precision values and a preset standard value, and correcting the attachment precision values of corresponding objects to be attached according to the attachment compensation amounts, the present application can automatically compensate the object attachment precision. Therefore, the present application does not require shutting down the machine during attachment precision compensation, does not influence the product capacity and device utilization rate of the machine, can avoid the problem that personal compensation amount calculation and manual operation are easy to make mistakes, can realize real time monitoring and automatic correction, and can remain the object attachment precision in a good stable state.

### BRIEF DESCRIPTION OF THE DRAWINGS

FIG. 1 is a use flow chart of the object attachment control method according to the first embodiment of the present application;

FIG. 2 is a schematic view of a workstation of the attaching machine adopting the object attachment control method according to the first embodiment of the present application;

FIG. 3 is a use flow chart of the object attachment control method according to the second embodiment of the present application;

FIG. 4 is a use flow chart of the object attachment control method according to the third embodiment of the present application;

FIG. 5 is a use flow chart of the object attachment control method according to the fourth embodiment of the present application;

FIG. 6 is a use flow chart of the object attachment control method according to the fifth embodiment of the present application;

FIG. 7 is a use flow chart of the object attachment control method according to the sixth embodiment of the present application; and

FIG. 8 is a use flow chart of the object attachment control method according to the seventh embodiment of the present application.

### DETAILED DESCRIPTION OF THE EMBODIMENTS

In the present application, the object may be a polarizing plate, or a liquid crystal panel such as a color filter, a thin film transistor and the like, or other objects such as paper, films and the like.

The present application will take the polarizing plate and the attachment of the polarizing plate as a preferred embodiment hereafter to perform description.

Polarizing plate is applied to a liquid crystal display. Polarized light is necessary to the imaging of the liquid crystal display. Each liquid crystal has a front polarizing plate and a back polarizing plate which closely presses against liquid crystal glass to form a liquid crystal panel; and the liquid crystal panel cannot display an image without any one polarizing plate. Therefore, the polarizing plate is an extremely important component of a liquid crystal display panel.

A control terminal can be implemented in various forms. For example, the control terminal described in the present application may comprise the mobile terminals such as a mobile terminal, a tablet computer, a notebook computer, a pocket PC, a personal digital assistant (PDA), a portable media player (PMA), a navigation device, a wearable device, a smart bracelet, a pedometer and the like, and can also be an integrated electric control device such as a control box and the like. When the control terminal is a control box, the control box is disposed in a power use loop, and is electrically connected to an attaching machine to form a circuit loop, such that the control box can control the attaching machine on the basis of the power use loop. Certainly, the control box can also communicate with the other terminals to interact data. The attaching machine is internally provided with a precision detector capable of detecting the object attachment precision in real time. The control terminal and the attaching machine can communicate in a wired or wireless manner. And the control terminal can control the operation of the attaching machine.

The present application solves the technical problems that when the attachment precision is manually compensated, the existing technology consumes much time, influences product capacity and device utilization rate, is easy to make mistakes, and cannot remain the attachment precision in a stable state. The technical solution of the present application does not require shutting down the machine during attachment precision compensation, does not influence the product capacity of the machine, can avoid the problem that personal compensation amount calculation and manual operation are easy to make mistakes, can realize real time monitoring and automatic correction, and can remain the object attachment precision in a good stable state.

To better understand the technical solution above, the exemplary embodiments of the present disclosure will be described in details hereafter with reference to the drawings. Although the exemplary embodiments of the present disclosure are shown in the drawings, it should be understood that the present disclosure can be realized in various forms and shall not be limited to the embodiments elaborated herein. On the contrary, the embodiments are provided such that the present disclosure can be understood more thoroughly and the scope of the present disclosure can be completely conveyed to a person skilled in the art.

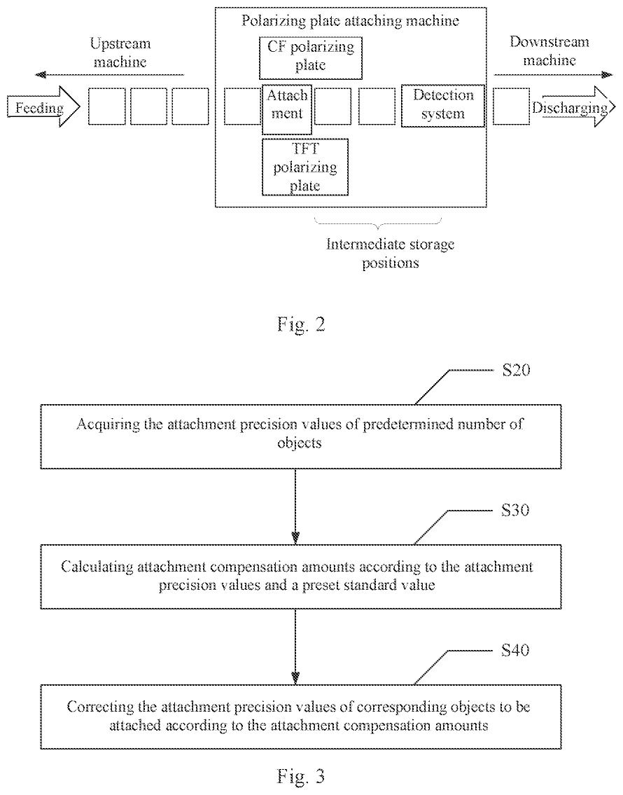

The present application provides an object attachment control method. In one embodiment, with reference to FIG. 3, the object attachment control method comprises the following steps:

Step S20, acquiring the attachment precision values of predetermined number of objects;

Alternatively, the range value of the predetermined number can be 1-50; certainly, the attachment precision values of other number of polarizing plates can also be acquired in specific application.

Step S30, calculating attachment compensation amounts according to the attachment precision values and a preset standard value;

Specifically, with reference to FIG. 6, the step S30 comprises:

Step S31, calculating the average of the attachment precision values; and

Step S32, comparing the average with the preset standard value to acquire the attachment compensation amounts.

The preset standard value is a target polarizing plate attachment precision value; the attachment compensation amount can be acquired by comparing the average with preset standard value and calculating a difference therebetween; the attachment compensation amount=practical average−the preset standard value.

For example, when the predetermined number is 50, the attachment compensation amount can be acquired by calculating the average of the acquired precision values of fifty polarizing plates, and calculating the difference between the average and the preset standard value.

Step S40, correcting the attachment precision values of corresponding objects to be attached according to the attachment compensation amounts.

A position alignment system can be used to automatically adjust the attachment of the polarizing plate according to the attachment compensation amount, so as to automatically compensate the attachment precision of the polarizing plate. Certainly, in specific application, the attachment compensation amount can also be inputted directly to the position alignment system to perform compensation, or inputted to the position alignment system according to a certain proportion of attachment compensation amounts (namely, the compensation amounts actually inputted to the position alignment system is less than or equal to the attachment compensation amounts). When the object attachment control method is applied to a polarizing plate attaching machine, the adjustment parameters of each worktable of the polarizing plate attaching machine comprise the parameters in X direction, Y direction and θ direction. That is, the polarizing plate has offsets in X direction and Y direction and deflections in θ angular direction during attachment. Therefore, the attachment precision value comprises the precision parameters in X direction, Y direction and θ direction.

In the embodiment of the present application, by acquiring the attachment precision values of predetermined number of objects, calculating attachment compensation amounts according to the attachment precision values and a preset standard value, and correcting the attachment precision values of corresponding objects to be attached according to the attachment compensation amounts, the present application can automatically compensate the object attachment precision. Therefore, the present application does not require shutting down the machine during attachment precision compensation, does not influence the product capacity and device utilization rate of the machine, can avoid the problem that personal compensation amount calculation and manual operation are easy to make mistakes, can realize real time monitoring and automatic correction, and can remain the object attachment precision in a good stable state.

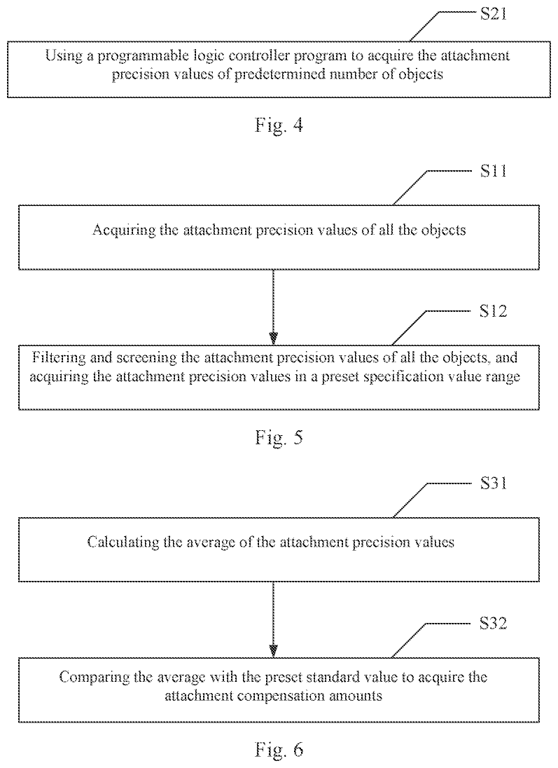

Alternatively, with reference to FIG. 4, the step S20 comprises

Step S21, using a programmable logic controller program to acquire the attachment precision values of predetermined number of objects.

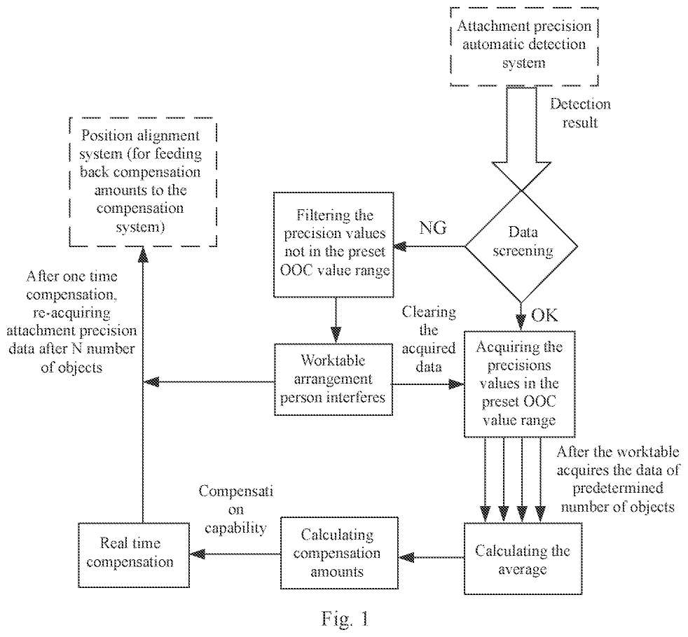

Specifically, PLC is a programmable logic controller. PLC adopts a programmable memory to store programs, execute user-oriented instructions such as logic operation, sequence control, timing, counting, arithmetic operation and the like, and controls various machines or production processes via a digital or simulated input/output. By configuring the PLC program, the worktable for attaching a polarizing plate automatically detects, automatically determines, and automatically compensate the polarizing plate attachment precision. The process persistently circulates in such a manner (as shown in the flow chart in FIG. 1), thus ensuring the polarizing plate attachment precision to be stable, improving the manufacture procedure capability of the worktable, optimizing a polarizing plate attachment flow, and improving polarizing plate attachment good rate.

Alternatively, with reference to FIG. 5, before the step S20, the method further comprises:

Step S11, acquiring the attachment precision values of all the objects; and

Step S12, filtering and screening the attachment precision values of all the objects, and acquiring the attachment precision values in a preset specification value range.

Specifically, when the polarizing plate attaching machine operates, the polarizing plate attaching machine detects the precisions of all the polarizing plates entering the worktable, filters and removes, according to a preset specification value range, the polarizing plate precision values out of the preset specification value range, and acquires the precision values in the preset specification value range. Therefore, the precision values acquired in step S20 are filtered precision values, thus improving the precision of the attachment compensation amounts.

Data screening: acquiring all the detection results of an attachment precision automatic detection system, removing the mistakenly acquired values and the attachment detection results out of specification (OOS, namely out of specification value range), and only acquiring the precision values in the preset specification value range. Wherein OOS has two situations: actually OOS and mistakenly acquired by the attachment detection system which both require manual interference and processing.

Attachment detection and filtering: automatically transferring the liquid crystal panels with precision values out of the preset specification value range to a manual detection department, and manually performing determination and processing. Wherein:

USL (upper specification limit)/LSL (lower specification limit) are a product property control range, and one of determination bases during production detection;

UCL (upper control limit)/LCL (lower control limit) are generally acquired through calculation by a formula and coefficients according to product and process properties and statistical data, and are limit values of a certain property set by a quality detector during product manufacturing to survey process stability;

In practical use, the attachment precision automatic detection system of the polarizing plate attaching machine acquires the precision values through detection. When a precision value falls in the range of LSL-USL, the precision value passes the examination; the better the value approximates to the standard value, the better.

When a precision value is in the ranges of LCL-LSL and UCL-USL), the precision value already exceeds a control value (namely the OOC value); the situation should be alert. However, the precision value is still in the preset specification value range, and shall still be selected as an attachment precision value;

When the attachment precision value is less than LSL or greater than USL, the precision value already exceeds the specification value (namely the OOS value), is not good, namely is already filtered out and should be manually interfered and processed.

When the attachment precisions are consecutively out of the specification value, a machine arrangement person should interfere and adjust the parameters.

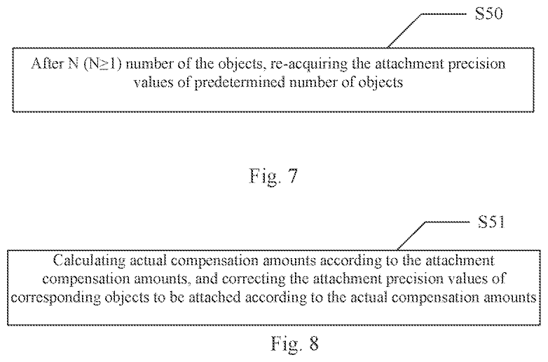

Alternatively, with reference to FIG. 7, after the step S40, the method further comprises:

Step S50, after N (N≥1) number of the objects, re-acquiring the attachment precision values of predetermined number of objects.

Specifically, as shown in FIG. 1, the polarizing plate attaching machine is generally provided with an attachment precision automatic detection system and a position alignment system, wherein at least one liquid crystal panel storage position is generally disposed between the attachment precision automatic detection system and the position alignment system. Preferably, in the N (N≥1) number of polarizing plates in step S50, N can be the number of the liquid crystal panel storage positions on the worktable of the polarizing plate attaching machine. It should be noted that: the types of polarizing plate attaching machines are different; therefore, different polarizing plate attaching machines have different number of storage positions which can be specifically set according to practical situations.

As shown in FIG. 2, the attachment precision automatic detection system and the position alignment system have three storage positions therebetween; after the attachment precision automatic detection system detects the attachment precision values through steps S10-S50, the attachment precision automatic detection system feeds back the attachment compensation amounts to the position alignment system; the position alignment system compensates the parameters, and then TFT polarizer and CF polarizer liquid crystal panels are attached. Therefore, the three liquid crystal panels located at the storage positions between the attachment precision automatic detection system and the position alignment system are attached before the compensation, and are not subject to attachment precision improvement yet. If the attachment precision automatic detection system continues to acquire the precision data of the three liquid crystal panels in this case, then the liquid crystal panels at the three storage positions would be continuously acquired. That is, the acquired precision values comprise the liquid crystal panels before the compensation. However, the liquid crystal panels are not subject to compensation precision improvement, and the liquid crystals subject to precision improvement are not transferred to the attachment precision automatic detection system yet. In this case, the liquid crystal panels prior to improvement would be calculated once again, thus causing repeated compensation which results in an over-compensation phenomenon. Therefore. N adopts the number of corresponding storage positions on the worktable of the polarizing plate attaching machine; and after N (N≥1) number of the polarizing plates, the attachment precision values of predetermined number of polarizing plates are re-acquired, thus avoiding repeated compensation which results in the over-compensation phenomenon.

Actual compensation amount=attachment compensation amount×compensation capability, wherein 0<compensation capability<100%.

With reference to FIG. 8, the step S50 comprises:

Step S51, calculating actual compensation amounts according to the attachment compensation amounts, and correcting the attachment precision values of corresponding objects to be attached according to the actual compensation amounts.

Specifically, when the polarizing plate attaching machine sequentially attaches a plurality of polarizing plates, the polarizing plate attachment precisions are in a fluctuating state. That is, different polarizing plates have different attachment precisions; during attachment, the precisions of a part of the polarizing plates are high, and the others are low. If the calculated attachment compensation amounts are directly used as actual compensation amounts to compensate to the position alignment system of the polarizing plate attaching machine, then a part of the polarizing plates would have the over-compensation problem. The polarizing plate attaching machine has a compensation capability. For example, if the calculated attachment compensation amount is 0.25 mm and the compensation capability is set as 50%, then the actual compensation amount actually written in the position alignment system is 0.25×50%=0.125 mm. Therefore, by setting the compensation capability, the polarizing plate attachment over-compensation problem can be avoided, thus improving attachment precision and stability.

Alternatively, the compensation capability is adjustable; and the adjustment range of the compensation capability is: 1%<compensation capability<100%.

Specifically, the compensation capability is adjustable. In practical use, the compensation capability can be set according to the operating situation of the polarizing plate attaching machine. For example, at a certain time, a worktable arrangement person manually sets the compensation capability to be 40% according to the operating situation of the attaching machine at the time; while at another time, the operating state of the attaching machine changes, then the worktable arrangement person can adjust the compensation capability to be 60% according to the operating situation of the attaching machine at the time. Therefore, the polarizing plate attaching machine has a better controllability, thus facilitating the in time adjustment of the attachment precisions, and further remaining the polarizing plate attachment precisions to be stable.

The present application further provides an attaching machine, comprising a memory, a processor, a precision detector, a worktable for attaching a polarizing plate, and an object attachment control program stored in the memory and capable of running on the processor, wherein the precision detector is disposed on the worktable, and is electrically connected to the processor; and the object attachment control program, when executed by the processor, realizes the steps of the above-described object attachment control method.

The present application further provides a control terminal, comprising a memory, a processor, and an object attachment control program stored in the memory and capable of running on the processor, wherein the object attachment control program, when executed by the processor, realizes the steps of the above-described object attachment control method.

The present application further provides a storage medium, stored with an object attachment control program for, when executed, realizing the steps of the above-described object attachment control method.

A person skilled in the art should understand that the embodiment of the disclosure can be provided as a method, a system or a computer program product. Therefore, the present application can adopt the forms of an entirely hardware embodiment, an entirely software embodiment or an embodiment combining hardware and software elements. Furthermore, the present application can adopt the form of a computer program product which can be executed by one or more computer usable storage mediums containing computer usable program codes therein (including but not limited to magnetic disk memory, CD-ROM, optical memory and the like).

The present application is described with reference to the flow charts and/or block diagrams of the method, device (system) and computer program product according to the embodiments of the present application. It will be understood that each flowchart and/or block in flowchart illustrations and/or block diagrams and the combination between flowchart and/or block in flowchart illustrations and/or block diagrams can be achieved by computer program instructions. The computer instructions can be provided to a general-purpose computer, a specialized computer, an embedded processor, or the processor of other programmable data equipment so as to give rise to a machine with the result that the commands executed through the computer or processor of other programmable data equipment give rise to a device that is used to realize the functions designated by one or more processes in a flow chart and/or one or more blocks in a block diagram.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the specified function in a flow chart and/or one or more blocks in a block diagram.

Such computer program instructions can also be loaded on computers or other programmable data processing equipment so as to carry out a series of operation steps on computers or other programmable equipment to generate the process to be achieved by computers, so that the commands to be executed by computers or other programmable equipment achieve the one or multiple flows in the flowchart and/or the functions specified in one block or multiple blocks of the block diagram.

It should be noted that in the claims, any reference symbols in brackets shall not constitute a restriction to the claims. The word “comprise” does not exclude the components or steps not listed in the claims. The word “one” or “a/an” before a component does not exclude the existence of a plurality of such components. The present application can be realized by means of hardware comprising a plurality of different components and a properly-programmed computer. In a unit claim listing a plurality of devices, the plurality of the devices can be specifically embodied through the same hardware. The use of the words “first”, “second”, “third” and the like does not represent any sequence. The words can be interpreted as names.

Although some embodiments of the present application are already described, once basic creative concepts are understood, a person skilled in the art can make further variations and modifications to the embodiments. Therefore, the appended claims are intended to include some embodiments and all the variations and modifications falling in the scope of the present application.

It would be apparent that a person skilled in the art could make various modifications and variations to the present application without departing from the spirit or scope of the present application. If these various modifications and variations of the present application belong to the scope of the claim and equivalent technical scope, the present application is intended to comprise these modifications and variations.

What is claimed is:

1. An object attachment control method, comprising the following steps:
acquiring the attachment precision values of predetermined number of objects;
calculating attachment compensation amounts according to the attachment precision values and a preset standard value; and
correcting the attachment precision values of corresponding objects to be attached according to the attachment compensation amounts.

2. The object attachment control method according to claim 1, wherein the step of acquiring the attachment precision values of predetermined number of objects comprises:
using a programmable logic controller program to acquire the attachment precision values of predetermined number of objects.

3. The object attachment control method according to claim 1, wherein before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range.

4. The object attachment control method according to claim 1, wherein the step of acquiring the attachment precision values of predetermined number of objects comprises:
using a programmable logic controller program to acquire the attachment precision values of predetermined number of objects;
before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range.

5. The object attachment control method according to claim 1, wherein the step of calculating attachment compensation amounts according to the attachment precision values and a preset standard value comprises:
calculating the average of the attachment precision values; and
comparing the average with the preset standard value to acquire the attachment compensation amounts.

6. The object attachment control method according to claim 1, wherein the step of acquiring the attachment precision values of predetermined number of objects comprises:
using a programmable logic controller program to acquire the attachment precision values of predetermined number of objects;
the step of calculating attachment compensation amounts according to the attachment precision values and a preset standard value comprises:
calculating the average of the attachment precision values; and
comparing the average with the preset standard value to acquire the attachment compensation amounts.

7. The object attachment control method according to claim 1, wherein before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range;
the step of calculating attachment compensation amounts according to the attachment precision values and a preset standard value comprises:
calculating the average of the attachment precision values; and
comparing the average with the preset standard value to acquire the attachment compensation amounts.

8. The object attachment control method according to claim 1, wherein the step of acquiring the attachment precision values of predetermined number of objects comprises:
using a programmable logic controller program to acquire the attachment precision values of predetermined number of objects;
before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range;
the step of calculating attachment compensation amounts according to the attachment precision values and a preset standard value comprises:
calculating the average of the attachment precision values; and
comparing the average with the preset standard value to acquire the attachment compensation amounts.

9. The object attachment control method according to claim 1, wherein after the step of correcting the attachment precision values of corresponding objects to be attached according to the attachment compensation amounts, the method further comprises:
after N (N≥1) number of the objects, re-acquiring the attachment precision values of predetermined number of objects;

10. The object attachment control method according to claim 1, wherein before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range;
after the step of correcting the attachment precision values of corresponding objects to be attached according to the attachment compensation amounts, the method further comprises:
after N (N≥1) number of the objects, re-acquiring the attachment precision values of predetermined number of objects;

11. The object attachment control method according to claim 1, wherein the step of acquiring the attachment precision values of predetermined number of objects comprises:
using a programmable logic controller program to acquire the attachment precision values of predetermined number of objects;
after the step of correcting the attachment precision values of corresponding objects to be attached according to the attachment compensation amounts, the method further comprises:
after N (N≥1) number of the objects, re-acquiring the attachment precision values of predetermined number of objects;

12. The object attachment control method according to claim 1, wherein the step of calculating attachment compensation amounts according to the attachment precision values and a preset standard value comprises:
calculating the average of the attachment precision values; and
comparing the average with the preset standard value to acquire the attachment compensation amounts;
after the step of correcting the attachment precision values of corresponding objects to be attached according to the attachment compensation amounts, the method further comprises:
after N (N≥1) number of the objects, re-acquiring the attachment precision values of predetermined number of objects;

13. The object attachment control method according to claim 1, wherein before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range;
the step of calculating attachment compensation amounts according to the attachment precision values and a preset standard value comprises:
calculating the average of the attachment precision values; and
comparing the average with the preset standard value to acquire the attachment compensation amounts;
after the step of correcting the attachment precision values of corresponding objects to be attached according to the attachment compensation amounts, the method further comprises:
after N (N≥1) number of the objects, re-acquiring the attachment precision values of predetermined number of objects;

14. The object attachment control method according to claim 1, wherein the step of acquiring the attachment precision values of predetermined number of objects comprises:
using a programmable logic controller program to acquire the attachment precision values of predetermined number of objects;
before the step of acquiring the attachment precision values of predetermined number of objects, the method further comprises:
acquiring the attachment precision values of all the objects; and
filtering and screening the attachment precision values of all the objects, and acquiring the attachment precision values in a preset specification value range;
the step of calculating attachment compensation amounts according to the attachment precision values and a preset standard value comprises:
calculating the average of the attachment precision values; and
comparing the average with the preset standard value to acquire the attachment compensation amounts;
after the step of correcting the attachment precision values of corresponding objects to be attached according to the attachment compensation amounts, the method further comprises:
after N (N≥1) number of the objects, re-acquiring the attachment precision values of predetermined number of objects;

15. The object attachment control method according to claim 1, wherein actual compensation amount=attachment compensation amount×compensation capability, 0<compensation capability<100%; and the step of correcting the attachment precision values of corresponding objects to be attached according to the attachment compensation amounts comprises:
calculating actual compensation amounts according to the attachment compensation amounts, and correcting the attachment precision values of corresponding objects to be attached according to the actual compensation amounts.

16. The object attachment control method according to claim 15, wherein the compensation capability is adjustable; and the adjustment range of the compensation capability is: 1%<compensation capability<100%.

17. The object attachment control method according to claim 1, wherein the objects are polarizing plates.

18. An attaching machine, comprising a memory, a processor, a precision detector, a worktable for attaching an object, and an object attachment control program stored in the memory and capable of running on the processor, wherein the precision detector is disposed on the worktable, and is electrically connected to the processor; and the object attachment control program, when executed by the processor, realizes the following steps of the attachment control method:
acquiring the attachment precision values of predetermined number of objects;
calculating attachment compensation amounts according to the attachment precision values and a preset standard value; and
correcting the attachment precision values of corresponding objects to be attached according to the attachment compensation amounts.

19. A storage medium, stored with an object attachment control program for, when executed, realizing the steps of the object attachment control method according to claim 1:
acquiring the attachment precision values of predetermined number of objects;
calculating attachment compensation amounts according to the attachment precision values and a preset standard value; and
correcting the attachment precision values of corresponding objects to be attached according to the attachment compensation amounts.
